(19) United States
(12) Patent Application Publication
(10) Pub. No.: US 2024/0261764 A1
(43) Pub. Date: Aug. 8, 2024

(54) PROCESSES FOR RECOVERING PFAS FROM SOLID SORBENTS

(71) Applicant: Enviropacific Services Limited, Macquarie Park (AU)

(72) Inventors: Ricky James LEGG, Golden Grove (AU); Cameron SHEARER, Adelaide (AU); John Dominic HAYBALL, Adelaide (AU); Luke Andrew PARKINSON, Kensington Park (AU)

(73) Assignee: Enviropacific Services Limited, Macquarie Park (AU)

(21) Appl. No.: 18/567,754

(22) PCT Filed: Jun. 7, 2022
(86) PCT No.: PCT/AU2022/050559

§ 371 Date: Dec. 6, 2023

(30) Foreign Application Priority Data
Jun. 7, 2021 (AU) 2021901696

(51) Int. Cl. B01J 20/34; B01J 20/20

(52) U.S. Cl. CPC B01J 20/3416; B01J 20/20; B01J 20/3441; B01J 20/3475

(57) ABSTRACT

A solvent extraction process for removing poly- and perfluoroalkyl substances (PFAS) from a PFAS laden adsorbent is disclosed. The process comprises introducing a substantially pure solvent at an elevated temperature to a bed of the PFAS laden adsorbent and continuously removing PFAS laden solvent from the adsorbent, wherein the introducing and removing are carried out simultaneously and continuously until a desired amount of PFAS is removed from the adsorbent. Also disclosed is a process for degrading poly- and perfluoroalkyl substances (PFAS) to environmentally benign products. The process comprises providing an aqueous solution containing PFAS at a concentration of greater than 50 ppm; and subjecting the aqueous solution to ultrasound using at least one ultrasonic transducer at a frequency and power and for a time sufficient to degrade substantially all of the PFAS in the solution to carbon dioxide and fluoride.

### PRIORITY DOCUMENT

The present application claims priority from Australian Provisional Patent Application No. 20219016% titled “PROCESSES FOR RECOVERING PFAS FROM SOLID SORBENTS” and filed on 7 Jun. 2021, the content of which is hereby incorporated by reference in its entirety.

### TECHNICAL FIELD

The present disclosure relates generally to handling of perfluoroalkyl substances (PFAS) contaminants and more specifically to processes for removing PFAS from solid substrates onto which PFAS is adsorbed.

### BACKGROUND

Poly- and perfluoroalkyl substances (PFAS) are a class of chemicals which consist of a hydrophobic tail of C—F bonds and a hydrophilic head group such as a carboxylic acid or sulfonate.[1] PFAS have a history of use in a wide range of applications but of note is their use in aqueous film forming foams (AFFF) and their release into the environment as part of firefighting use, exercises and accidental release of stockpiles.[2] Subsequently water sources worldwide are contaminated with PFAS levels greater than the current USEPA drinking water limit of 0.07 μg/L.[3] More concerning is the detection of PFAS in the bloodstream of individuals who have not been directly exposed.[4]

PFAS do not naturally degrade in the environment and therefore immediate remediation strategies are required to remove PFAS from water sources and soil worldwide.[5] Ideally PFAS would be destroyed in situ but due to the very low concentration of PFAS in most environments these strategies are not feasible. Instead, capture and destroy (or store) strategies are the most feasible for effective remediation.

PFAS are commonly captured from water using ion-exchange resins, reverse osmosis, and activated carbon, including granular activated carbon (GAC). Adsorption technologies are at a stage where they are in use to capture PFAS from water sources on an industrial scale. GAC is the simplest and currently most cost effective method for the adsorption of GAC from high volume of contaminated water.[7]

However, there is yet to be an economic and environmentally responsible method to regenerate or dispose of PFAS contaminated adsorbent. GAC is generally regenerated via high temperature steam treatment.[8] This process would release PFAS, requiring capture again, if it is even shown to be effective at removing PFAS. Thermal destruction of PFAS on GAC has been investigated with some promising laboratory results,[9] but the large scale implementation of this process has not been successful and GAC is thermally oxidised in the process and therefore not regenerated. Experts at a 2020 PFAS workshop agreed there are currently no destruction methods that have demonstrated acceptable results in the safe breakdown of PFAS impacted media.[10] Consequently, PFAS impacted adsorbents must either be stored or the PFAS must be successfully eluted from the adsorbent for it to be used again.

After the elution of PFAS from an adsorbent, a procedure for PFAS destruction (or storage) must be in place. The difficulty in degrading PFAS is that the breakdown products of PFAS include shorter chain PFAS liquids (potentially toxic) or gases (CF4, greenhouse gas). Therefore it is imperative that any destruction method completely mineralizes PFAS to carbon dioxide and fluoride. So far ultrasonic destruction has the most promising results for the reliable mineralization of PFAS with proven complete conversion.[14] Ultrasonic waves induce bubbles via cavitation which rapidly collapse and can induce temperatures in the range of 2000-4000K.[15] PFAS molecules are amphiphilic and migrate to the vapour-water interface of these cavitation bubbles and are subsequently thermally degraded as the bubbles collapse.[14] Sonication has the ability to scale without significant challenge in engineering with examples reported of PFOS degradation in a 91 L reactor which could treat flowing water.[16] The cost of ultrasonic destruction of 200 nM PFO(A or S) has been calculated to be US$10 m⁻³ (assuming electricity cost of 8.14 c/kWh).[17]

There is thus a need for processes for eluting PFAS from solid adsorbents that overcome one of more of the problems associated with known processes. Alternatively, or in addition, there is a need for more efficient processes for eluting PFAS from solid adsorbents. Alternatively, or in addition, there is a need for processes for destroying PFAS that overcome one of more of the problems associated with known processes. Alternatively, or in addition, there is a need for more efficient processes for destroying PFAS.

### SUMMARY

The present disclosure arises from the inventors' research into processes for the safe disposal or destruction of PFAS from PFAS contaminated media.

In a first aspect, disclosed herein is a solvent extraction process for removing poly- and perfluoroalkyl substances (PFAS) from a PFAS laden adsorbent, the process comprising introducing a substantially pure solvent at an elevated temperature to a bed of the PFAS laden adsorbent and continuously removing PFAS laden solvent from the adsorbent, wherein the introducing and removing are carried out simultaneously and continuously until a desired amount of PFAS is removed from the adsorbent.

In some embodiments, the introducing and removing are carried out in a Soxhlet extraction apparatus.

In some embodiments, the solvent is a low ionic strength solvent. In certain of these embodiments, the solvent is an alcohol solvent such as a C₁-C₆ alcohol. The C₁-C₆ alcohol may be selected from the group consisting of methanol, ethanol and n-propanol. In certain specific embodiments, the C₁-C₆ alcohol is methanol.

In some embodiments, the elevated temperature is at or near the boiling point of the solvent. In certain of these embodiments, the elevated temperature is greater than about 60° C.

In some embodiments, the adsorbent is activated carbon. In certain of these embodiments, the activated carbon is granular activated carbon (GAC).

In some embodiments, the process provides a regenerated adsorbent that is suitable for re-use as an adsorbent for PFAS.

In some embodiments, the process provides a PFAS laden solvent.

In a second aspect, disclosed herein is a process for regenerating an adsorbent from a PFAS laden adsorbent, the process comprising subjecting the PFAS laden adsorbent to the process of the first aspect.

In a third aspect, disclosed herein is a regenerated adsorbent that is suitable for use as an adsorbent for PFAS, said adsorbent obtained from the process of the first aspect.

In a fourth aspect, disclosed herein is a PFAS laden solvent obtained from the process of the first aspect.

In a fifth aspect, disclosed herein is a process of continuous Soxhlet extraction for the removal of poly- and perfluoroalkyl substances (PFAS) from a PFAS laden adsorbent comprising:
assembling a flask, an extractor with a liquid arm dimensioned to enable continuous solvent flow and a condenser,
placing the PFAS laden adsorbent in the extractor and solvent in the flask; and
heating the solvent to create a flow of the solvent through said condenser, extractor and flask for removal of poly- and perfluoroalkyl substances (PFAS) from the PFAS laden adsorbent.

In some embodiments, the extractor is a Soxhlet extractor.

In some embodiments, the PFAS laden adsorbent is placed within a glass or cellulose thimble within said extractor.

In some embodiments, the solvent is a low ionic strength solvent. In certain of these embodiments, the solvent is an alcohol solvent such as a C₁-C₆ alcohol. The C₁-C₆ alcohol may be selected from the group consisting of methanol, ethanol and n-propanol. In certain specific embodiments, the C₁-C₆ alcohol is methanol.

In some embodiments, the elevated temperature is at or near the boiling point of the solvent. In certain of these embodiments, the elevated temperature is greater than about 60° C.

In some embodiments, the adsorbent is activated carbon. In certain of these embodiments, the activated carbon is granular activated carbon (GAC).

In a sixth aspect, disclosed herein is a process of degrading poly- and perfluoroalkyl substances (PFAS) to environmentally benign products, the process comprising:
providing an aqueous solution containing PFAS at a concentration of greater than 50 ppm;
subjecting the aqueous solution to ultrasound using at least one ultrasonic transducer at a frequency and power and for a time sufficient to degrade substantially all of the PFAS in the solution to carbon dioxide and fluoride.

In some embodiments, the frequency of the ultrasonic transducer is at least 1000 kHz. In certain of these embodiments, the frequency of the ultrasonic transducer is 1140 kHz.

In some embodiments, the power of the ultrasonic transducer is at least 200 W/L input. In certain of these embodiments, the power of the ultrasonic transducer is 250 W/L input.

In some embodiments, the concentration of PFAS in the aqueous solution is about 75 ppm.

In some embodiments, the PFAS is degraded at a rate of at least about 1 mg per hour. In certain of these embodiments, the PFAS is degraded at a rate of at from about 1 mg per hour to about 2 mg per hour.

In some embodiments, the aqueous solution containing PFAS is obtained from a PFAS laden solvent obtained from the process of the first aspect. In certain of these embodiments, the aqueous solution containing PFAS is obtained by removing substantially all of the solvent from the PFAS laden solvent to provide a crude PFAS composition and then mixing the crude PFAS composition with water to provide the aqueous solution containing PFAS.

In a seventh aspect, disclosed herein is a system for removing poly- and perfluoroalkyl substances (PFAS) from a PFAS laden sorbent and degrading PFAS to environmentally benign products, the system comprising:
a solvent extraction station configured to introduce a substantially pure solvent at an elevated temperature to a bed of the PFAS laden adsorbent and continuously remove PFAS laden solvent from the adsorbent, wherein the introducing and removing are carried out simultaneously and continuously;
a PFAS degradation station configured to degrade PFAS obtained from the solvent extraction station, the degradation station comprising at least one ultrasonic transducer configured to expose an aqueous solution of the PFAS obtained from the solvent extraction station to ultrasound at a frequency and power and for a time sufficient to degrade substantially all of the PFAS in the solution to carbon dioxide and fluoride.

### BRIEF DESCRIPTION OF DRAWINGS

Embodiments of the present disclosure will be discussed with reference to the accompanying figures wherein:

FIG. 1 shows data for the Soxhlet elution of PFOA from GAC with varying solvent. Reaction conditions=PFOA loading ˜3 μg(PFOA)/g(GAC), Soxhlet time=24 hours.

FIG. 2 shows data for the Soxhlet elution of PFOA from GAC with varying PFOA loading. Reaction conditions: solvent=methanol, Soxhlet time=24 hours.

FIG. 3 shows data for the tumbling elution of PFOA from GAC with varying solvents and duration. PFOA loading on GAC=˜3 μg/g. ASTM D7968-14 used a solvent of 1:1 methanol:water with pH adjusted to 9 by addition of ammonium hydroxide. For comparison, Soxhlet elution in methanol recorded 66% elution.

FIG. 4 shows data for the sonication assisted elution of PFOA from GAC with varying solvents. PFOA loading on GAC=˜3 μg/g, sonication duration was 40 minutes with solvent replaced 1 time. For comparison, Soxhlet elution in methanol recorded 66% elution.

FIG. 5 shows data for the GAC regeneration with Soxhlet extraction in methanol. Repeated PFOA loading (3 mg(PFOA/g(GAC)) and elution (Soxhlet, methanol, 24 hours) using the same GAC for 5 cycles.

FIG. 6 shows data for the change in PFOA maximum loading and kinetics with GAC regeneration via Soxhlet in methanol. Plot shows change in PFOA loading onto GAC with time for 100 mL 500 ppm PFOA stirring with 0.1 g of GAC. GAC is taken from different number of PFOA loading and Soxhlet regeneration cycles (data shown in FIG. 5), for example 2× Regen is GAC after cycle 2 and 4× Regen is GAC after cycle 4.

FIG. 7 shows data for the (a) PFOA adsorption and Soxhlet elution (in methanol) from GAC with Dissolved Organic Matter (DOM). (b) DOM adsorption and elution concurrent with PFOA. Repeated PFOA loading (3 mg(PFOA)/g(GAC)) and elution (Soxhlet, methanol, 24 hours) using the same GAC for 3 cycles.

FIG. 8 shows data for the PFAS elution using Soxhlet extraction in methanol for 24 hours. Each PFAS was loaded to ˜1 μg/g (total PFAS loading=5 μg/g). The experiment was completed in duplicate with average value reported, error bars are 10% of value. Acronyms used: PFBA (perfluorobutanoic acid), PFPeA (perfluoropentanoic acid), PFHpA (perfluoroheptanoic acid), PFNA (perfluorononoic acid), PFOS (perfluorooctanesulfonic acid).

FIG. 9 shows data for the kinetic release of PFAS during Soxhlet elution from GAC showing release of (a) PFOA, (b) PFOS, (c) PFBA, and (d) PFDA over 94 hours. Conditions: PFAS loading of 1 μg/g for each PFAS; solvent=methanol; error bars are 10% of value. Labelled numbers are the percentage released at each timepoint, assuming 100% release at maximum recorded concentration.

FIG. 10 shows data for the PFAS elution from GAC used at an industrial PFAS treatment plant. 20 g of dried GAC from either the front (Bay 1) or middle (Bay 3) of the plant was treated by Soxhlet elution in methanol (300 mL) for 24 hours. Inlet water prior to adsorption in Bay 1 was also tested.

FIG. 11 shows data for the ultrasonic PFOA destruction showing measured PFOA with ultrasonic treatment time. Conditions: 1140 kHz, 250 W/L, 600 mL, 20° C.

FIG. 12 shows a schematic for the treatment chain for the remediation of PFAS contaminated water sources including capture, elution and destruction of PFAS and capture, regeneration and reuse of GAC.

FIG. 13 shows data for the determination of input power from ultrasonicator (1140 kHz) via calorimetry. 1 L of water was subjected to ultrasonication for 60 seconds. Slope of temperature change when ultrasonicator is switched on is used to determine P using P=m.Cp.dT/dt where m is the mass of water, Cp is the heat capacity of water, dT/dt is the slope.

FIG. 14 shows data for the GAC regeneration with Soxhlet extraction in methanol. Repeated PFOA loading (3 mg(PFOA/g(GAC)) and elution (Soxhlet, methanol, 24 hours) using the same GAC for 5 cycles. These results area duplicate experiment to those presented in FIG. 5.

FIG. 15 shows data for the kinetic release of PFAS during Soxhlet elution from GAC showing release of (a) PFPeA, (b) PFHpA, (c) PFNA, and (d) combined PFAS over 94 hours. Conditions: PFAS loading of 1 μg/g for each PFAS; solvent=methanol; error bars are 10% of value. Labelled numbers are the percentage released at each time point, assuming 100% release at maximum recorded concentration.

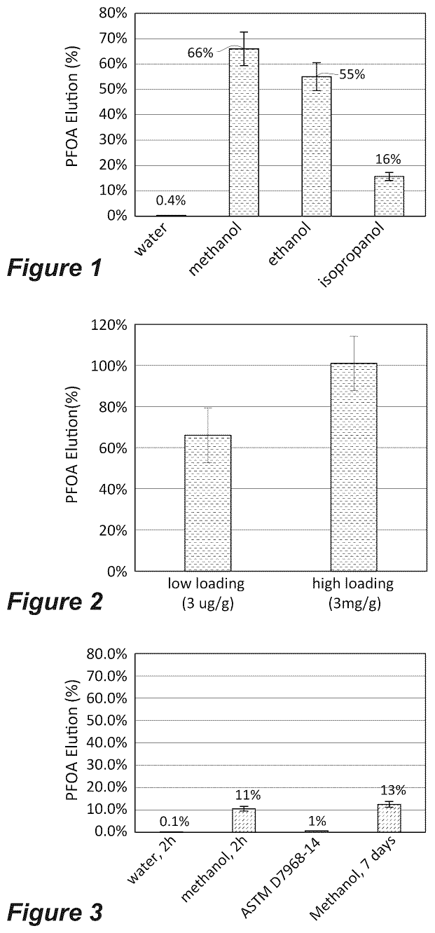

### DESCRIPTION OF EMBODIMENTS

The present disclosure arises from developments by the current inventors of processes for the elution of PFAS from GAC for the regeneration of GAC and environmentally responsible storage or destruction of PFAS. Soxhlet extraction in methanol showed a higher elution efficiency (66%) than other known techniques. The efficiency increased with PFAS loading to 100% at 3 mg (PFAS)/g(GAC). After elution the GAC was shown to exhibit similar maximum adsorption capacity for up to 5 cycles. Soxhlet elution in methanol was applied to GAC from a commercial water treatment plant and is used to determine GAC exhaustion and provided insight into PFAS mobility within a large bed of GAC. Subsequently, PFAS eluted in methanol was destroyed by first recovering the methanol, transferring the PFAS to an aqueous suspension and then degrading the PFAS ultrasonically to produce only carbon dioxide and fluoride. This efficient process may be used to remediate PFAS contaminated sites worldwide in a closed process loop.

Disclosed herein is a solvent extraction process for removing poly- and perfluoroalkyl substances (PFAS) from a PFAS laden adsorbent. The process comprises introducing a substantially pure solvent at an elevated temperature to a bed of the PFAS laden adsorbent and continuously removing PFAS laden solvent from the adsorbent, wherein the introducing and removing are carried out simultaneously and continuously until a desired amount of PFAS is removed from the adsorbent.

The solvent extraction process can be carried out using any suitable extraction apparatus that allows substantially pure solvent to be continuously introduced to the bed of the PFAS laden adsorbent and for PFAS laden solvent to be continuously removed from the adsorbent. A Soxhlet extraction apparatus is particularly suitable. Soxhlet extraction is a cyclic process in which solvent is refluxed and then collected in a chamber housing the solid material, allowed to fill until emptied (along with eluted material) into the boiling flask and the process is repeated, each time filing the chamber with distilled, hot solvent. To the best of the present inventors' knowledge, Soxhlet has not been used for the elution of PFAS from solid adsorbents such as GAC.

The present inventors' research has shown that removal of PFAS from PFAS laden adsorbent is more efficient using the process described herein than with prior art methods such as tumbling or ultrasonication.

The solvent may be a low ionic strength solvent. An alcohol solvent, for example a C₁-C₆ alcohol, may be suitable. The C₁-C₆ alcohol may be selected from the group consisting of methanol, ethanol and n-propanol. In certain advantageous embodiments, the solvent is methanol. Methanol may be a preferred solvent for PFAS elution from GAC due to its ability to (1) displace PFAS from GAC and (2) solubilize PFAS in the liquid phase to prevent readsorption to the GAC.[11] However, most prior art processes with GAC report relatively low elution with typical values of about 40%.[11] The accepted reason is the high affinity of PFAS for GAC the high surface area and internal pore structure of GAC leading to a high likelihood of readsoprtion of PFAS onto the adsorbent.[12] The method for GAC elution typically involves shaking the GAC in solvent mixture for 1-12 hours.

The elevated temperature at which the substantially pure solvent contacts the bed of PFAS laden adsorbent may be at or near the boiling point of the solvent. In certain embodiments, the elevated temperature is greater than about 60° C.

The adsorbent may be any solid PFAS adsorbent such as activated carbon or ion exchange resin. The activated carbon is granular activated carbon (GAC). For example, the PFAS laden sorbent may be obtained from the present applicant's PFAS removal system as described in published international patent application No. WO 2020/023993, the details of which are incorporated herein by reference.

Following extraction with solvent for a desired time period, the process provides a regenerated adsorbent that is suitable for re-use as an adsorbent for PFAS and a PFAS laden solvent.

This process may be used to regenerate an adsorbent from a PFAS laden adsorbent.

As discussed, the process may be carried out using a Soxhlet extraction apparatus. Therefore, also disclosed herein is a process of continuous Soxhlet extraction for the removal of poly- and perfluoroalkyl substances (PFAS) from a PFAS laden adsorbent. The process comprises assembling a flask, an extractor with a liquid arm dimensioned to enable continuous solvent flow and a condenser, placing the PFAS laden adsorbent in the extractor and solvent in the flask; and heating the solvent to create a flow of the solvent through said condenser, extractor and flask for removal of poly- and perfluoroalkyl substances (PFAS) from the PFAS laden adsorbent.

The extractor may be a Soxhlet extractor. The PFAS laden adsorbent may be placed within a glass or cellulose thimble within said extractor.

Also disclosed herein is a process of degrading poly- and perfluoroalkyl substances (PFAS) to environmentally benign products. The process comprises providing an aqueous solution containing PFAS at a concentration of greater than 50 ppm; and subjecting the aqueous solution to ultrasound using at least one ultrasonic transducer at a frequency and power and for a time sufficient to degrade substantially all of the PFAS in the solution to carbon dioxide and fluoride.

In certain embodiments, the frequency of the ultrasonic transducer is at least 1000 kHz.

In certain embodiments, the frequency of the ultrasonic transducer is 1140 kHz.

In certain embodiments, the power of the ultrasonic transducer is at least 200 W/L input. For example, the power of the ultrasonic transducer may be 250 W/L input.

In certain embodiments, the concentration of PFAS in the aqueous solution is about 75 ppm.

In certain embodiments, the PFAS is degraded at a rate of at least about 1 mg per hour, such as from about 1 mg per hour to about 2 mg per hour.

In certain embodiments, at least 65% fluoride is recovered from the PFAS in the degradation process.

The process of degrading poly- and perfluoroalkyl substances (PFAS) to environmentally benign products may be carried out on an aqueous solution containing PFAS that has been obtained from a PFAS laden solvent obtained from the process as described herein. More specifically, the aqueous solution containing PFAS may be obtained by removing substantially all of the solvent from the PFAS laden solvent to provide a crude PFAS composition and then mixing the crude PFAS composition with water to provide the aqueous solution containing PFAS.

Also disclosed herein is a system for removing poly- and perfluoroalkyl substances (PFAS) from a PFAS laden sorbent and degrading PFAS to environmentally benign products. The system comprises a solvent extraction station configured to introduce a substantially pure solvent at an elevated temperature to a bed of the PFAS laden adsorbent and continuously remove PFAS laden solvent from the adsorbent, wherein the introducing and removing are carried out simultaneously and continuously; and a PFAS degradation station configured to degrade PFAS obtained from the solvent extraction station, the degradation station comprising at least one ultrasonic transducer configured to expose an aqueous solution of the PFAS obtained from the solvent extraction station to ultrasound at a frequency and power and for a time sufficient to degrade substantially all of the PFAS in the solution to carbon dioxide and fluoride.

### EXAMPLES

### Chemicals, Materials and Reagents

Perfluorobutanoic acid (PFBA, 99%, CAS=375-22-4, Alfa Aesar), Perfluoropentanoic acid (PFPeA, 97%, CAS=2706-90-3, Alfa Aesar), Perfluoroheptanoic acid (PFHpA, 98%, CAS=375-85-9, Alfa Aesar), Perfluorooctanoic acid (PFOA, 96%, CAS=335-67-1, Sigma—Aldrich), Perfluorononanoic acid (PFNA, 97%, CAS=375-95-1, Alfa Aesar), Pefluorodecanoic acid (PFDA, 97%, CAS=335-76-2, Alfa Aesar), Perfluorooctanesulfonic acid (PFOS, 100 ppm in methanol, CAS=1763-23-1, Supelco), Humic acid (HA, CAS=1415-93-6, Aldrich), Methanol (liquid chromatography grade, CAS=67-56-1, Merck), water (ultra pure, 18.2 MΩ·cm, Arium pro, Sartorius), 2,2,2-Trifluoroethanol (TFE, >99%, CAS=75-89-8), Sigma-Aldrich), Iron (III) acetylacetonate (Fe(acac), CAS=14024-18-1, Oakwood chemical), Deuterium oxide (D20, 99.9%, CAS=7789-20-0, Cambridge Isotope Laboratories Inc.).

PFAS standard solutions of 500 ppm in methanol were prepared and kept in the dark in a refrigerator for up to 30 days. PFAS concentration was measured before each use.

Activated Carbon (GAC, Acticarb GS900, 8×30 mesh), sourced from steam activated coal, was purchased from Activated Carbon Technologies Pty Ltd (Australia).

### List of PFAS Acronyms

Many PFAS were observed from samples collected from the field that were not purchased, the following is a list of these chemicals.

Perfluorobutane sulfonic acid (PFBS), Perfluoropentane sulfonic acid (PFPeS), Perfluorohexane sulfonic acid (PFHxS), Perfluoroheptane sulfonic acid (PFHpS), Perfluorodecane sulfonic acid (PFDS), Perfluorohexanoic acid (PFHxA), Perfluoroundecanoic acid (PFUnDA), Perfluorododecanoic acid (PFDoDA), Perfluorotridecanoic acid (PFTrDA), Perfluorotetradecanoic acid (PFTeDA), Perfluorooctane sulfonamide (FOSA), N-Methyl perfluorooctane sulfonamide (MeFOSA), N-Ethyl perfluorooctane sulfonamide (EtFOSA), N-Methyl perfluorooctane sulfonamidoethanol (MeFOSE), -Ethyl perfluorooctane sulfonamidoethanol (EtFOSE), N-Methyl perfluorooctane sulfonamidoacetic acid (MeFOSAA), N-Ethyl perfluorooctane sulfonamidoacetic acid (EtFOSAA), 4:2 Fluorotelomer sulfonic acid (4:2 FTS), 6:2 Fluorotelomer sulfonic acid (6:2 FTS), 8:2 Fluorotelomer sulfonic acid (8:2 FTS), 10:2 Fluorotelomer sulfonic acid (10:2 FTS).

Batch Adsorption of PFAS onto GAC

PFAS adsorption onto GAC was completed in batch conditions in order to quantify expected loading of PFAS onto the GAC with PFAS loading homogenous throughout the GAC particles. In general experiments were completed under 3 different PFAS loadings onto the GAC in g(PFAS) per g(GAC). Standard conditions were 3 μg(PFAS)/g(GAC) which was chosen based on the calculated PFAS loading of carbon after 1 year at a PFAS capture pilot plant. High PFAS loading of 3 mg(PFOA)/g(GAC) was chosen to allow the quantification of PFAS adsorption and elution by NMR to allow a rapid generation of results. Maximum PFAS loading experiments were completed to test the adsorption limit of the GAC, in which the PFAS concentration and mass of GAC were chosen such that a PFAS loading of up to 500 mg(PFAS)/g(GAC) was possible, which is far greater than values reported in the literature (typically 200 mg(PFAS)/g(GAC)).[1]

### PFOA Standard Conditions

A solution of 1 ppm PFOA in water was prepared by diluting a sample of 500 ppm PFOA in methanol. 100 mL of 1 ppm PFOA was poured into a 250 mL PP container with screw cap lid containing 20 g of GAC. The mixture was agitated in an orbital shaker (Major Sciences, MS-NOR) operating at 150 rpm for 24 hours.

The GAC was then filtered by vacuum directly into a pre-weighted Soxhlet thimble (Glass microfiber, 30×100 mm, Whatman). The filtrate was collected and measured to determine the PFAS loading on the GAC. The GAC was dried at 55° C. for 48 hours.

### High PFOA Loading

High PFOA loading experiments were completed using 500 ppm PFOA (by dissolving PFOA in water with brief sonochemical assistance). All other procedures were the same as the PFOA standard conditions described above.

### Maximum PFOA Loading

100 mL of 500 ppm PFOA was poured into a 250 mL PP container (with screw cap lid) containing 0.10 g of GAC. The mixture was placed on an orbital shaker operating at 150 rpm. Samples were withdrawn at desired time intervals over 7 days with a syringe or pipette. The solution was centrifuged at 3000 rpm for 3 minutes (Eppendorf, mini spin plus) to remove carbon fines before measurement.

### Multiple PFAS Testing

Experiments including multiple PFAS were completed using each PFAS at 0.2 ppm (total PFAS concentration of 1-2 ppm), diluted from standard solutions in methanol (described in the Chemical, Materials and Reagents section above). Adsorption experiments carried out as described in PFOA standard conditions above.

### Soxhlet

### Soxhlet Method

Soxhlet glassware with extractor capacity of 250 mL was purchased from Glassco Laboratory Equipments Pvt. Ltd. (Haryana, India). The typical procedure was to add 3 boiling chips and 300 mL of methanol to the round bottom flask before loading the Soxhlet extractor containing the thimble containing PFAS loaded GAC (cooled to RT and weighed). The apparatus was completed with an Allihin condenser with room temperature water flow. Silicone based vacuum grease was lightly applied to all ground joints. The flask was heated with a mantle (Electromantle), and the glassware was wrapped in aluminium foil to reduce heat loss. Typical times for the filling of the Soxhlet extractor with methanol was 30-45 minutes. Soxhlet extraction was completed for 24 hours (typical reaction).

### Additional Experiments

The kinetics of elution was determined by running Soxhlet with a 2 necked round bottom flask. The side neck was stoppered with a glass stopper. Samples were extracted with a syringe after completion of a methanol siphon.

Other solvents investigated were ultra-pure water, ethanol and isopropanol.

### Characterisation—NMR

NMR analysis was based on the work of Moody et. al.[18] 600 μL of sample (in water or methanol) was mixed with 60 μL trifluoroethanol (4618 ppm, 5 μL TFE into 1.5 mL D2O) as internal standard and 40 μL iron acetylacetonate (25 mg in 1 mL methanol) as relaxation agent.

NMR was carried out using a Bruker Avance III 500 MHz and analysed including phase adjustment, background subtraction and integration using Bruker TopSpin 3.6.2.

Analysis was completed by comparing the integrated area of the terminal CF3 group in TFE vs the terminal CF3 group of the PFAS molecule detected. Calibration curves were created weekly with limit of detection of 10 ppm.

### Characterisation—LC-MS

Liquid chromatography—mass spectrometry was carried out by a NATA accredited analysis laboratory using EPA method 537. Samples were stored in polypropylene bottles. Some concentrated PFAS samples in methanol were directly injected into the LC-MS.

### Alternative Elution Methods

Due to the limited literature for extracting PFAS from activated carbon, comparison methods were chosen based on standard methods for extracting PFAS from contaminated soils.

### Tumbling

ASTM D7968-14 for determining PFAS contamination in soil uses tumbling to remove PFAS. 10 g PFOA loaded GAC ((˜3 g/g) is placed in a 50 mL PP Falcon tube. 30 mL of solvent is added and mixture is tumbled (Benchmark rotating mixer, 30 rpm) for 1 hour. The solution is decanted and a further 30 mL of solvent is added and the Falcon tube is tumbled for another 1 hour. The GAC and solution are filtered by vacuum filtration. Both filtrate solutions are combined and analysed by EPA method 537.

Solvents investigated were water, methanol and 1:1 methanol water with 0.2% ammonium hydroxide.

### Sonication

Sonication extraction was completed following a published protocol.[19] 2 g of PFOA loaded GAC (˜3 μg/g) was measured into a 50 mL PP falcon tube. 30 mL of methanol was added and the tube was ultrasonicated in a sonication bath (40 kHz, 100 W, Unisonics Australia) for 30 minutes. The solution was removed by vacuum filtration (glass microfibre, grade 393, Filtech) and the GAC was resuspended in 30 mL of fresh methanol, sonicated a further 30 minutes and then filtered again. The filtrate solutions were combined and PFAS elution was determined by EPA method 537.

The experiment was also completed using water as solvent. Reference [19] uses methanol with 1% ammonia. Since pure methanol was found to be more effective than methanol/ammonia in tumbling extraction, pure methanol was used.

### GAC Regeneration

To investigate if the adsorptive capacity of GAC was changed after Soxhlet extraction of PFAS, GAC was subjected to a series of PFAS loading followed by Soxhlet extraction experiments.

### Repeated Experiments

GAC was loaded with 3 mg/g PFOA following details in the High PFOA loading section above and then subjected to Soxhlet extraction in methanol for 24 hours following details in the Soxhlet method section. The extracted GAC in the thimble was dried in an oven at 55° C. for 48 hours and then weighed into a 250 mL PP container with lid for PFAS loading experiments. This process was repeated 5 times and the experiment was completed in duplicate. About 0.1 g of GAC was retained at each step for characterisation.

Experiments with Humic Acid

The effect of organic matter (OM) on PFAS capture and Soxhlet elution was investigated since OM is present in many PFAS contaminated water sources at significantly higher concentrations than PFAS (ppm vs ppt). Humic Acid (HA) was used as a surrogate for OM. In these experiments GAC was loaded with 3 mg/g PFOA following details in the High PFOA loading section above with 500 ppm HA also present in the solution during adsorption (final HA maximum loading was also ˜3 mg/g). The carbon was filtered and dried and PFAS and HA were extracted with methanol following the procedure provided in the Soxhlet method section above. The same carbon was used for 3 repeats of this process to determine carbon regeneration under these conditions.

500 ppm HA was close to the solubility limit of HA. Experiments with higher concentration were not possible. Since all previous PFOA loading experiments were completed with 100 mL solution and 20 g GAC it was decided to keep these values consistent. Subsequently the obtained HA loading of 3 mg/g was the highest possible under these conditions.

### Regeneration of Carbon Used Infield Study

GAC used at a groundwater (with PFAS above 70 ppt) treatment plant in South Australia was tested. The GAC had been used for 4 months. The treatment plant consists of ultrafiltration followed by a long series of loosely packed GAC. GAC was collected from two sections of the plant (start and middle).

### Drying and Treatment of Carbon Prior to Soxhlet

GAC from the plant was dried in an oven at 55° C. for 48 hours. 20 g of dried GAC was weighed and then was then washed with 5×100 mL of water until the filtrate was visually clear. The GAC was then dried again at 55° C. for 48 hours. Soxhlet extraction in methanol was then completed following details in in the Soxhlet method section above.

### Calculation of PFAS Adsorption and Elution

### Calculation of PFAS Loading and Adsorption % on GAC

PFAS loading (LoadingPFAS, μgPFAS/gGAC) was calculated from the mass of GAC used (mGAC, g), concentration of PFAS used for adsorption ([PFAS]i, μg/L or ppb), volume of PFAS solution used (VPFAS,i, L) and concentration of filtrate solution after adsorption ([PFAS]filt, μg/L), as follows:

$${Loading}_{PFAS} ( \frac{μ {g}_{PFAS}}{{g}_{GAC}} ) = \frac{[ {PFAS}_{i} ] \cdot {V}_{PFAS} - {[ PFAS ]}_{filt} \cdot {V}_{PFAS}}{{m}_{GAC}}$$

PFAS adsorption (% Ad_{PFAS}) was calculated as follows:

$$\% {Ads}_{PFAS} = ( 1 - \frac{{[ PFAS ]}_{filt} \cdot {V}_{PFAS}}{{[ PFAS ]}_{i} \cdot {V}_{PFAS}} ) \times 100$$

Calculation of PFAS Elution from GAC

PFAS elution (% ElutPFAS) was calculated from PFAS loading (μgPFAS/gGAC), mass of dried GAC used with that loading (mGAC,elut, g), PFAS concentration of filtrate after elution([PFAS]elut, μg/L), and Volume of filtrate after elution (Velut,filt, L), as follows:

$$\% {Elut}_{PFAS} = ( \frac{{m}_{GAC , elut} \cdot {Loading}_{PFAS}}{{[ PFAS ]}_{elut} \cdot {V}_{elut , filt}} ) \times 100$$

### Sources of Error in Calculations

It is experimentally challenging to maintain a constant volume of liquid before and after adsorption and also before and after elution. Even with vacuum filtration to capture liquid, there is still significant loss of volume ˜ 15% (1-2 g solvent per g of GAC) due to the adsorption of liquid into the initially dry GAC. In both cases it was chosen to take the conservative values. Volume for adsorption is assumed to be equal to the initial volume (which would overestimate PFAS loading). Volume for elution uses the final volume collected (typically ˜250 mL from 300 mL starting, which underestimates PFAS elution).

### Ultrasonic Destruction of PFAS

Ultrasonic destruction was carried out using an ultrasonic power multifrequency generator (250 W, Meinhardt Ultrasonics, Germany) with an ultrasonic transducer (E/805/T/M) operating at 1140 kHz. The input power was determined with calorimetric method to be 82 W/L (˜32% of input power), see FIG. 13.[20]

Procedures were carried out in a custom 1 L glass reactor (Meinhardt Ultrasonics, UST 02/1000) with flange connection directly to the transducer. 600 mL of PFOA solution was added (90 ppm or 5 ppm). The solution was mixed by peristaltic pump (0.15 L/min). The reactor was cooled with flowing water through the cooling jacket (10° C.). The solution was left to mix for 1 hour to prevent effect of PFOA adsorption before taking a sample for t=0 minutes. The solution was subjected to ultrasonic treatment in 60 minute steps with samples withdrawn and heat of solution and power generator monitored. Reactions were completed in air and without any active bubbling of gas.

### Results

### Soxhlet Elution Including Effect of Solvent and PFAS Loading

Initial experiments were completed using PFOA adsorbed to GAC with loading of ˜3 μg(PFOA)/g(GAC). This value was considered to be an approximate loading of PFAS on GAC after 1 year operation at a local PFAS treatment facility (considering the level of PFAS contamination, volume of water treated and mass of GAC in the plant). 24 hours of Soxhlet treatment with 300 mL of solvent was completed on the GAC in water, methanol, ethanol and isopropanol with results shown in FIG. 1. It was observed that water was not at all effective at eluting PFOA (0.4%) while each of the alcohol solvents had varying degrees of elution. Methanol (66%) was the most effective with a trend of increasing size of molecule leading to a reduction in elution efficiency with ethanol (55%) and isopropanol (16%).

Methanol has been reported by several groups to be a preferred solvent for PFAS elution from GAC.[11] Although previous results have shown typical elution values of about 40%.[11] These results were obtained by shaking GAC in solvent at room temperature. Our results highlight the advantage of Soxhlet extraction in that each subsequent cycle is using pure solvent and the solvent is heated to just below boiling point which will maximise both PFAS solubility and reduce the non-covalent binding of PFAS to the GAC.

Another factor which may affect PFAS elution is the initial PFAS loading on the GAC. Experiments were completed to compare the PFOA elution from GAC with a low loading (3 g/g) with a high loading (3 mg/g). We find a 101% (13 repeats) elution from PFOA with high loading compared to 66% (3 repeats) at low loading. Our explanation is that there are some sites in the GAC which have such high affinity for PFOA that it will not be eluted regardless of the conditions, which lead to about 1p g(PFOA)/g(GAC) which are not able to be eluted. At high loading this small amount of GAC likely remains but as a % of the total PFOA (0.03%) it is insignificant.

Comparison Between Soxhlet Elution with Other Elution Methods

### Tumbling

Experiments were completed to compare the effectiveness of Soxhlet extraction with known PFAS elution procedures, namely tumbling and sonication.

Tumbling involved measuring PFOA loaded GAC (3 μg/g) into a 50 mL conical tube along with 30 mL of solvent. The tube was then rotated for the desired time with solution replaced either hourly (for 2 hour experiments) or daily. The solutions were combined and measured for PFOA. Results for tumbling elution are presented in FIG. 3. Only 0.1% of PFOA was eluted in water, similar to Soxhlet elution, while methanol recorded 11% elution after 2 hours which increased to 13% after 7 days. This value is significantly less elution than the 66% recorded for Soxhlet elution over 24 hours. A solvent system of 1:1 methanol:water with pH adjusted to 9 (from ASTM D7968-14) was also used. PFOA elution was 1% which is significantly less than pure methanol and marginally improved from water.

The poor elution when using water/methanol at pH 9 gives insight into the adsorption mechanism of PFOA onto the GAC used in the experiment. Methanol is used to disrupt hydrophobic interactions between the GAC and the C—F groups of PFAS. While aqueous solutions with basic pH are used to disrupt the interactions of the PFAS head groups with hydrophilic components of the adsorbent.[1] ASTM D7968-14 is a soil washing method and has been optimised for the interactions involved in soil which will involve a high proportion of head group interactions.

With pure methanol significantly outperforming aqueous mixtures we have strong evidence that hydrophobic interactions are the predominant interaction between PFAS and the GAC investigated.

### Sonication

Sonication elution is known, although it is primarily used in soil washing strategies.[19] Sonication was completed by adding PFOA loaded GAC into a 50 mL conical tube with 20 mL solvent. This was bath sonicated for 20 min, the solution was decanted and 20 mL fresh solvent was added and sonicated for a further 20 minutes. The solvent was collected by filtration and combined with the initially decanted solvent.

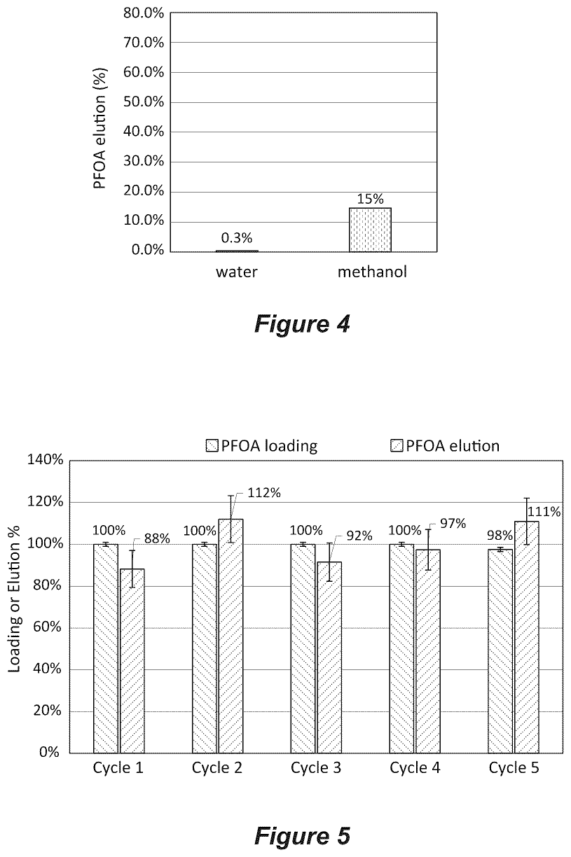

FIG. 4 shows the sonication assisted PFOA elution from GAC in water and methanol. We observe again very low elution in water (0.3%) and elution of 15% in methanol. The obtained value is similar to that obtained from tumbling assisted elution (11-13%) but far less than observed for Soxhlet elution (66%).

During the sonication assisted elution it was also observed that the GAC particles were breaking down and carbon fines were created. The production of fines is detrimental to the process of re-using the GAC since fines can cause clogging of GAC adsorbent beds.

### Comparison of Methods

From the methods investigated, Soxhlet extraction far outperforms tumbling and sonication. Soxhlet extraction has the advantage of consistent automatic replenishing solvent without manual interference. The solvent was manually changed also for both sonication or tumbling, but not the same rate or number of times as occurs in Soxhlet extraction. However, the tumbling result comparing 2 hours (solvent replaced twice) to 7 days (solvent replaced 5 times) shows little improvement (11 vs 13%) despite the increased duration of experiment and changes to the solvent.

The other advantage of Soxhlet extraction is the elevated temperature of the solvent. This variable was not applied to sonication or tumbling, but cannot be underestimated as a source of the improved elution using Soxhlet extraction.

Regeneration of GAC Via Soxhlet Elution—Repeated Loading and Elution of PFOA from GAC

In addition to eluting PFAS from GAC we also wanted to quantify if the GAC was regenerated and could be re-used for PFAS adsorption. This was investigated by monitoring the adsorption and elution of PFOA from GAC over 5 cycles. A PFOA loading of ˜3 mg(PFOA)/g(GAC) was chosen as it is a PFOA loading that is considered well above expectations of field samples.

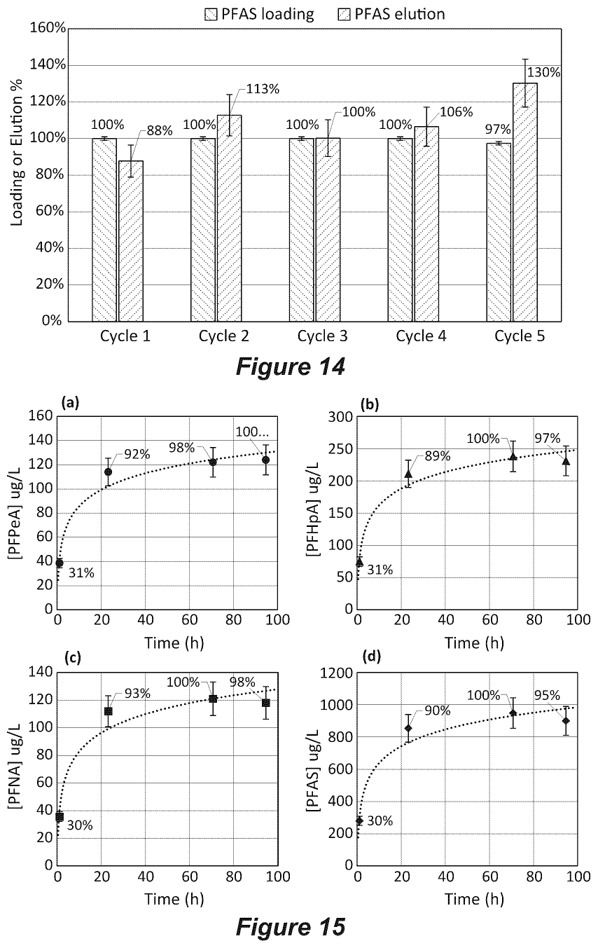

FIG. 5 shows the percentage of PFOA loaded and then eluted from GAC in repeated cycles using the same GAC. The adsorption remains at 100% for the first 4 cycles and drops a small margin by the fifth cycle (98±1%). The elution follows a similar trend with all values in the range of 88-112%. As discussed earlier, there is an experimental error in the final volume of solution after Soxhlet which is responsible for the large error bar in those values. Despite possible errors in the measurement, it is clear that both adsorption and elution continue to show high efficiency throughout the cycles. This experiment was completed in duplicate with results between experiments in good agreement (FIG. 14).

Regeneration of GAC Via Soxhlet Elution—Testing of GAC Maximum Adsorption Capacity with Regeneration

Although the experiments in FIG. 5 were completed with PFOA loading which exceeds an expected loading from GAC used in the field, it is difficult to ascertain if the maximum adsorption capacity of the GAC is being reduced with Soxhlet treatment since the GAC is adsorbing 100% of the PFOA in the batch adsorption reactions. Further experiments were completed to determine if the adsorption capacity of GAC is decreased with cycling. To achieve this, PFOA was loaded onto GAC using PFOA concentrations that would result in adsorption under 100%.

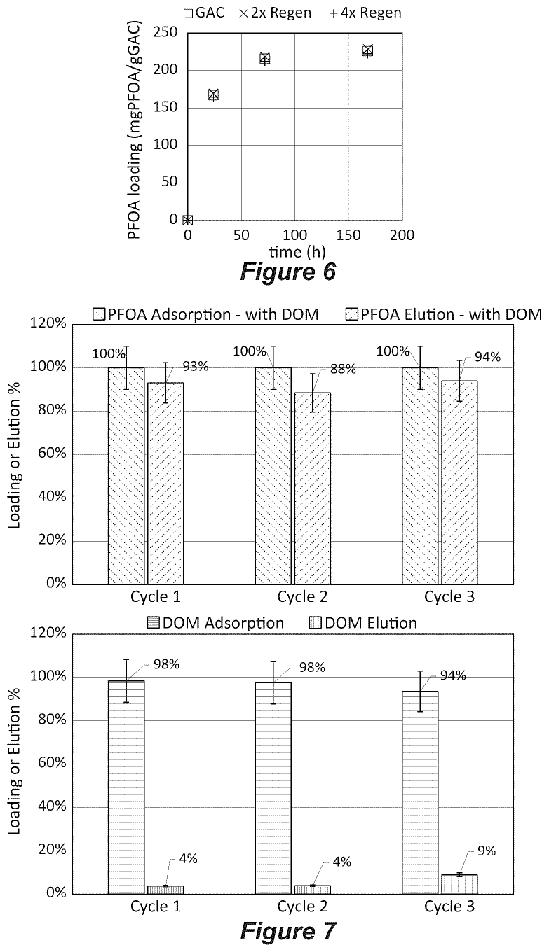

FIG. 6 shows PFOA loading with time for the maximum loading experiment over 7 days. From an initial solution of 500 ppm PFOA, the remaining PFOA concentration was greater than 240 ppm in all experiments. The slope of each of the plots indicates the PFOA loading is at or very near equilibrium maximum loading under the conditions investigated. With repeated GAC regeneration (2× Regen and 4× Regen are after Cycle 2 and cycle 4 from the experiment shown in FIG. 5) there is no observable difference in the maximum PFOA loading which is 223±4 mg (PFOA)/g(GAC).

The data in FIG. 6 can also be used to compare the kinetics of PFOA adsorption with the GAC by completing Freundlich analysis. From the slope of the line a rate constant of adsorption is obtained. The values for GAC, 2× Regen, 4× Regen was identical within 3 significant figures with a value of 4.22×10-2 mg(PFOA)/g(GAC)/h obtained.

### Effect of Organic Matter on Soxhlet Elution

PFAS contamination in the environment, particularly in groundwater, is in the ppb (μg/L) to ppt (ng/L) range. Other contaminants in water are present in much higher concentration and are therefore likely to be present during the adsorption and elution of PFAS. The material with highest expected concentration is dissolved organic matter (DOM) which is a class of compounds predominantly formed by the breakdown of matter (plants, animals) into small organic molecules.[21] DOMs are typically found in ground water at levels in the mg/L range.

To investigate the effect of DOMs on PFOA adsorption and Soxhlet elution, experiments were conducted with 500 ppm humic acid, which is a common representative for DOMs. The adsorption and elution of PFOA was completed in the same manner as the data presented in the Regeneration of GAC via Soxhlet elution—Repeated loading and elution of PFOA from GAC section and the adsorption and elution of HA was monitored by Fluorescence emission excited at 250 nm.

FIG. 7 (a) shows the obtained adsorption (%) and elution (%) of PFOA with DOM adsorption and elution in FIG. 7 (b). PFOA adsorption remains 100% for each cycle and elution is within error of the experiment without DOM (FIG. 5). The DOM adsorption is less than 100% in each cycle and during the experiment it was observed the solution changed colour from a dark brown to a translucent brown (but not clear). This indicates either the adsorption capacity was reached or the material remaining in solution had a low affinity for GAC. Considering the total loading of material was ˜6 mg(PFOA+DOM)/g(GAC) which is far lower than the maximum PFOA adsorption determined in the Regeneration of GAC via Soxhlet elution—Testing of GAC maximum adsorption capacity with regeneration section (˜223 mg(PFOA)/g(GAC)) it is more likely the remaining material had a low affinity for adsorption to GAC.

The elution of DOM is very low (less than 10%) which is not surprising considering the poor solubility of HA in low ionic strength solvents such as methanol.[22] However, it is not shown to be detrimental to either the PFOA adsorption or elution under the conditions investigated. Ideally both DOMs and PFAS would be eluted for GAC regeneration. In the field, either procedures to remove DOMs from water before PFAS capture (such as chlorine or ozone treatment)[23] would need to be completed or DOMs would need to be removed by backwashing in water or any high ionic strength solvent before PFAS removal by Soxhlet extraction in methanol.

### Effect of PFAS Type

All previous experiments were completed using PFOA as model compound for all PFAS. To ensure the results of Soxhlet elution were not due to an unforeseen property of PFOA, Soxhlet elution was completed using GAC contaminated with PFAS with increasing chain length (C4, C5, C7, C9) but also with sulfonate head group (C8, PFOS). All of these PFAS were loaded onto carbon with final PFAS loading of ˜5 μg/g (low loading, field relevant) with each individual PFAS loaded at approx. 1 μg/g.

FIG. 8 shows the elution efficiency obtained for each PFAS investigated. We observe very little difference in elution compared to PFOA (65±7%, FIG. 1). In addition chain length or head group do not have a significant effect (not greater than error in experiment). Considering the high solubility of each of these PFAS molecules in methanol it is not surprising that little difference is observed. The PFAS used in firefighting foams has been found to consist of thousands of different PFAS molecules.[24] The non-specific nature of elution is important that it can be applied to all possible PFAS.

### Kinetics of PFAS Elution

A kinetic study of the elution of PFAS was conducted to determine the optimal time period of Soxhlet elution and also to determine if the elution kinetics change with PFAS type (e.g. do shorter PFAS elute earlier). PFAS contaminated carbon (total PFAS=5 μg/g, ˜1 μg/g for each PFAS) was regenerated using Soxhlet elution in methanol for 4 days with samples withdrawn at 1 hour, 24 hours, 70 hours, 94 hours.

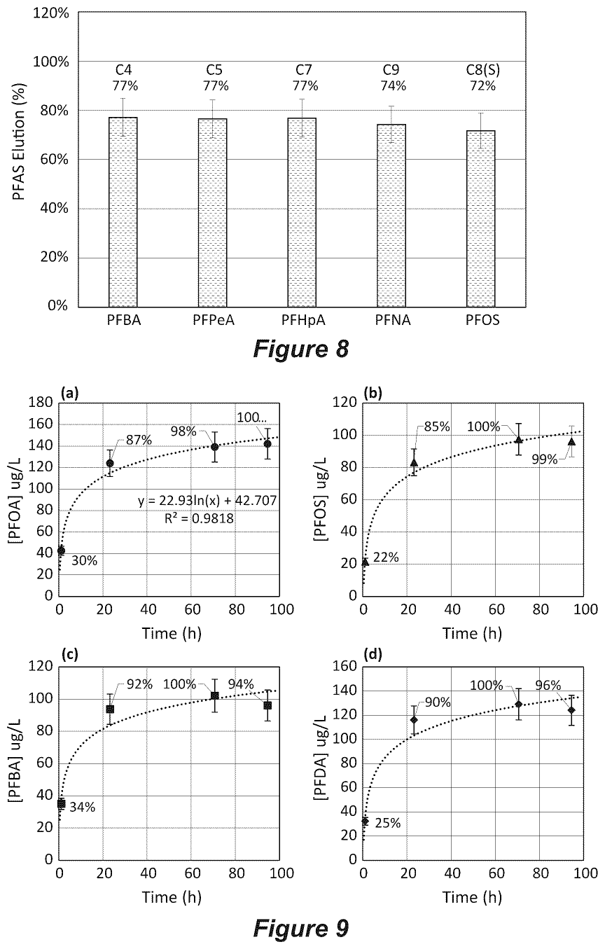

The PFAS release over 94 hours of PFOA, PFOS, PFBA and PFDA are shown in FIG. 9. Release of PFPeA, PFHpA, PFNA and combined PFAS are presented in FIG. 15. The data is presented with recorded concentration of PFAS (μg/L, ppb) on the y-axis. Each PFAS shows a similar logarithmic profile of release with pseudo first order kinetics. The line of best fit presented in each plot is a natural logarithm and R² value of over 0.9 was obtained in each case. PFAS release follows a rapid initial release over the first 24 hour, with over 85% released in that time in all PFAS studied, followed by a very gradual release with very little difference observed in each case between 72 hours and 98 hours. Considering the energy required for Soxhlet elution to continue it may prove to be more cost effective to stop elution at 24 hours and re-use the GAC with a small amount of remaining, strongly adsorbed, PFAS. The first collection (1 h) shows the largest variation between PFAS with shorter chain PFAS recording higher values (PFBA=34%, PFPeA=31%) than longer chain PFAS (PFDA=25%) which may indicate faster release with shorter perfluoro chain length. Also, PFOS (22%) shows lower release after 1 hour than PFOA (30%) which may indicate the sulfonate group results in stronger anchoring to GAC or may have less solubility in methanol. Regardless of the initial rate, by 24 hours there is little difference (within 7%) between the PFAS investigated.

Application of Soxhlet Elution to GAC from Commercial Treatment Plant

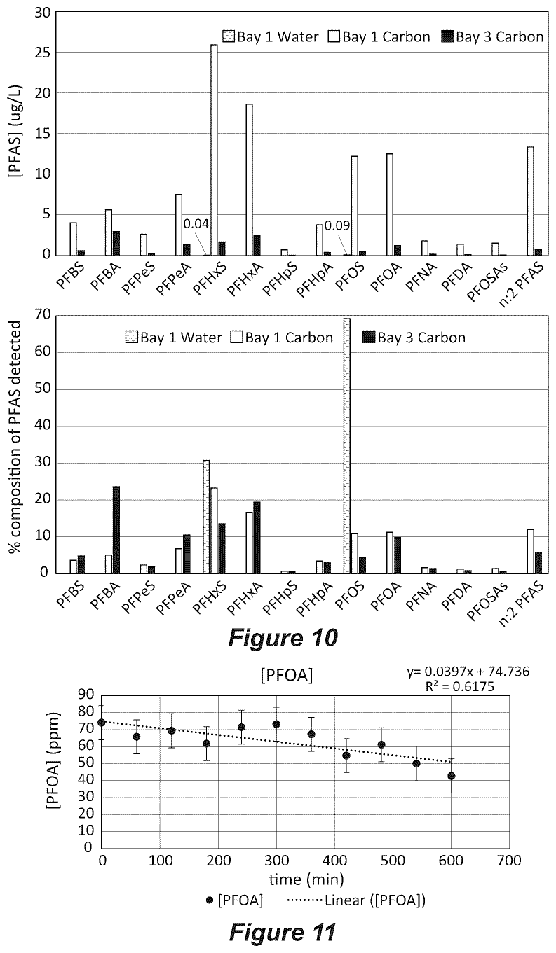

GAC that had been used to treat PFAS contaminated groundwater at an industrial scale plant for several months was obtained from Membrane Systems Australia. The plant is capable of treating up to 2 mL per day. The inlet water had been treated with ultrafiltration prior to adsorption onto a large loosely packed GAC filtration bed. GAC was obtained from the front end (Bay 1) and middle (Bay 3) of the filtration bed. After ultrafiltration the water was tested and 0.09 ppb PFOS and 0.04 ppb PFHxS were recorded (FIG. 10). This value is above the local EPA limit for drinking water (0.07 ppb) and is consistent with groundwater contaminated by the aqueous film forming foam 3M Light Water™ which was used regularly at a nearby Royal Australian Air Force base until 2005.[2c]

The carbon was washed with water until the filtrate was clear, then dried prior to Soxhlet extraction in methanol for 24 hours. FIG. 10 (a) shows the PFAS concentration of the methanol solution after Soxhlet for carbon from Bay 1 and Bay 3 while FIG. 10 (b) shows the data as a % of all PFAS measured. There are a number of interesting observations.

Despite only PFOS and PFHxS being detected in the inlet water (limit of reporting=0.02 ppb) a range of PFAS were eluted from the GAC which may result from side products of PFOS and PFHxS electrochemical production or may be the result of the legacy use multiple AFFF liquids.[2c, 25] The most abundant PFAS from both Bays are C6 PFAS (PFHxS and PFHxA), not the expected C8 PFOS. Considering Soxhlet elution showed similar rate and quantity between C6 and C8 in previous experiments (FIG. 9), it is difficult to determine the cause for this. There may be an instrumental error in assigning the peaks from LC-MS in a complicated matrix.

As expected, Bay 1 has significantly higher PFAS loading than Bay 3 indicating most PFAS capture is occurring at the start of the filtration bed but the observation of PFAS from Bay 3 is indicating one of the following: (a) some PFAS is bypassing a significant mass of GAC (unlikely), (b) Bay 1 is overloaded and PFAS is bypassing, (c) PFAS is adsorbing and desorbing from GAC and travelling through filtration bed. The data in FIG. 10 (b) suggests adsorbing and desorbing of PFAS may be occurring since shorter PFAS (C4-C5) are present in higher % composition in Bay 3 while longer chain PFAS (C6-C10, PFOSAs and n:2 PFAS) are present in higher % composition in Bay 1. This suggests the more water soluble PFAS may be more mobile in the GAC filtration bed.

In addition to observing PFAS we also sought to determine loading of DOMs and trichloroethane (TCE). TCE was not detected (LOR 5 μg/L) but may have evaporated during the Soxhlet process. DOMs were detected at a high quantity with the methanol solution turning a brown colour during the extraction process (even after washing the carbon with water prior to Soxhlet). The concentrations of DOMs were determined using Fluorescence emission after excitation at 250 nm (calibrated to signal from Humic acid). Bay 1 eluted DOMs at a concentration of 378 mg/L while Bay 3 recorded 78 mg/L. These values are orders of magnitude higher than the PFAS eluted.

To put the concentration of eluted PFAS in context Table 1 shows the loading of PFAS in μg(PFAS)/g(GAC) with values of 1.5 and 0.17 μg/g obtained. The 1.5 μg/g PFAS is similar to the values used in experiments in this manuscript (˜3 μg/g for the ‘low loading’ experiments). The high loading of DOMs indicates that DOMs will be responsible for overloading the GAC and allowing PFAS breakthrough. Since it is easier to monitor the loading of DOMs on GAC (and also in water) this can be used as a quick method to predict GAC exhaustion.

TABLE 1
Summary of PFAS and DOM loading on carbon extracted
from an Industrial PFAS treatment plant.

| | | |
|---|---|---|
| Sample | Bay 1 | Bay 3 |

| Chemical | units | Carbon | Carbon |
|---|---|---|---|
| DOMs | mg/g | 5.15 | 1.09 |
| Sum of | μg/g | 1.52 | 0.17 |
| PFAS | | | |

### PFAS Treatment Chain for Groundwater

Rapid remediation of contaminated water is required at sites worldwide to ensure not only the safe use of the contaminated water source but also to prevent the spread of PFAS contamination to connecting water sources. The efficacy of Soxhlet extraction to both elute PFAS and regenerate GAC is promising for the capture of PFAS from high volume of contaminated water and transferring to low volume of solvent (methanol).

Currently PFAS destruction methods are unreliable in their ability to controllably breakdown PFAS into non-toxic by-products. One of the better understood breakdown methods is ultrasonic destruction which has been shown to mineralize PFAS into carbon dioxide and fluoride.[14, 26]

Ultrasonic destruction of PFAS eluted from GAC will require solvent recovery of methanol (e.g. rotary distillation) and transfer of PFAS into water. The recovered solvent can be reused for PFAS elution. The PFAS concentrate in water, when subjected to high frequency, high power ultrasonic waves is expected to degrade rapidly to carbon dioxide and fluoride. Previous research has shown that higher frequency,[17] higher power,[17] high PFAS concentration,[16] low VOC contamination[26] and bubbling with gas with higher thermal conductivity (e.g. Ar)[27] lead to greater rates of PFAS destruction (mg PFAS destroyed per hour).

As proof-of-concept we have investigated the degradation of PFOA using a high frequency (1140 kHz), high power (250 W/L input) ultrasonic transducer to destroy PFOA (600 mL, 75 ppm). FIG. 11 shows the ultrasonic PFOA destruction results. Over 10 hour, the [PFOA] shows a quasi-linear decrease from 75 ppm to 40 ppm. The linear plot indicates zero-order kinetics (not dependant on concentration of PFOA), which has been previously reported for ultrasonic destruction of PFAS at concentrations greater than 1 ppm.[28] The average destruction rate was 1.9 mg(PFOA) per hour or 45.6 mg per day.

A groundwater treatment plant operating at 1 mL/day with PFAS contamination of 0.1 ppb would capture 100 mg of PFAS per day. It is feasible that a series of ultrasonic degradation reactors could keep up with the demand to destroy the captured PFAS.

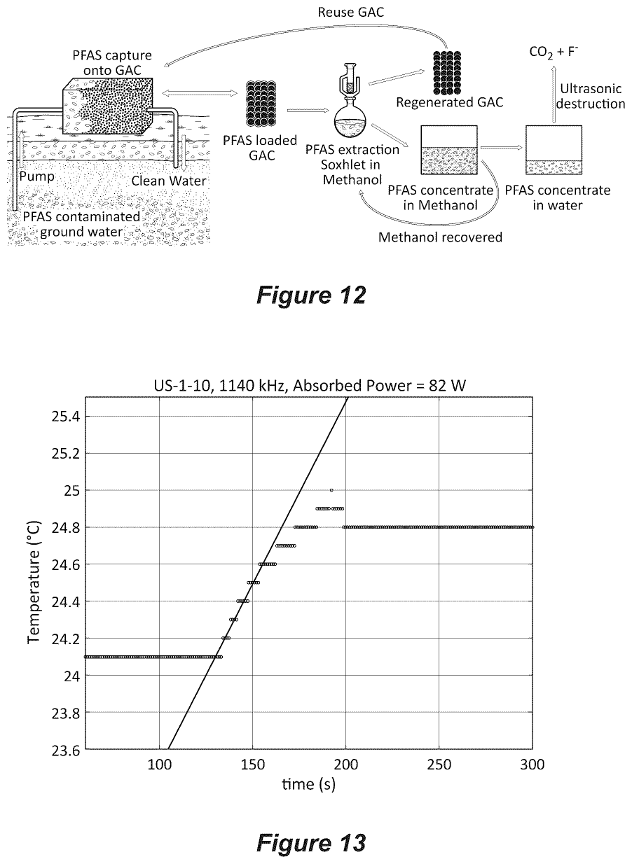

These results indicate a treatment chain of PFAS capture via filtration with GAC, followed by PFAS elution and GAC regeneration by Soxhlet in methanol, followed by solvent recovery and exchange to create concentrated PFAS in water which is then mineralized to carbon dioxide and fluoride is a feasible protocol for the remediation of PFAS in the environment. This treatment chain is depicted in FIG. 12.

### CONCLUSIONS

Soxhlet extraction with methanol solvent has been shown to elute PFAS from GAC with higher efficiency than the more common tumbling or sonication methods. Higher PFAS loading increases elution efficiency. After Soxhlet regeneration the GAC has been shown to maintain its PFAS adsorptive capacity for up to 5 cycles. Dissolved organic matter does not reduce elution efficiency but elution in methanol is not effective at removing adsorbed organic matter. Soxhlet was applied to carbon obtained from a commercial PFAS treatment plant and was used to monitor PFAS loading and also to monitor how PFAS travels through the GAC bed.

Finally, we report a complete PFAS treatment chain that involve adsorption, elution and ultrasonic destruction of PFAS into environmentally safe products. These results are applicable toward a remediation process of PFAS in waterways and may be applied immediately.

It will be understood that the terms “comprise” and “include” and any of their derivatives (eg comprises, comprising, includes, including) as used in this specification is to be taken to be inclusive of features to which the term refers, and is not meant to exclude the presence of any additional features unless otherwise stated or implied

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein.

It will be appreciated that the disclosure is not limited to the embodiment or embodiments disclosed, but is capable of numerous rearrangements, modifications and substitutions without departing from the scope as set forth and defined by the following claims.

### REFERENCES

[1] D. Q. Zhang, W. L. Zhang, Y. N. Liang, Science of The Total Environment 2019, 694, 133606.
[2] aC. A. Moody, J. A. Field, Environmental Science & Technology 1999, 33, 2800-2806; bO. Weiβ, G. A. Wiesmüller, A. Bunte, T. Göen, C. K. Schmidt, M. Wilhelm, J. Hölzer, International Journal of Hygiene and Environmental Health 2012, 215, 212-215; cJBS&G, 2018.
[3] aX. C. Hu, D. Q. Andrews, A. B. Lindstrom, T. A. Bruton, L. A. Schaider, P. Grandjean, R. Lohmann, C. C. Carignan, A. Blum, S. A. Balan, C. P. Higgins, E. M. Sunderland, Environmental Science & Technology Letters 2016, 3, 344-350; bS. Banzhaf, M. Filipovic, J. Lewis, C. J. Sparrenbom, R. Barthel, Ambio 2017, 46, 335-346.
[4] aK. J. Hansen, L. A. Clemen, M. E. Ellefson, H. O. Johnson, Environmental Science & Technology 2001, 35, 766-770; bA. M. Calafat, L.-Y. Wong, Z. Kuklenyik, J. A. Reidy, L. L. Needham, Environmental Health Perspectives 2007, 115, 1596-1602; cX. Ye, K. Kato, L.-Y. Wong, T. Jia, A. Kalathil, J. Latremouille, A. M. Calafat, International Journal of Hygiene and Environmental Health 2018, 221, 9-16.
[5] aY. Miyake, N. Yamashita, P. Rostkowski, M. K. So, S. Taniyasu, P. K. S. Lam, K. Kannan, Journal of Chromatography A 2007, 1143, 98-104; bL. W. Y. Yeung, A. O. De Silva, E. I. H. Loi, C. H. Marvin, S. Taniyasu, N. Yamashita, S. A. Mabury, D. C. G. Muir, P. K. S. Lam, Environment International 2013, 59, 389-397; cJ. Meng, T. Wang, S. Song, P. Wang, Q. Li, Y. Zhou, Y. Lu, Environmental Pollution 2018, 238, 404-412; dA. Kärrman, K. Elgh-Dalgren, C. Lafossas, T. Møskeland, Environmental Chemistry 2011, 8, 372-380; eM. Filipovic, A. Woldegiorgis, K. Norström, M. Bibi, M. Lindberg, A.-H. Österås, Chemosphere 2015, 129, 39-45; fL. Ahrens, K. Norström, T. Viktor, A. P. Cousins, S. Josefsson, Chemosphere 2015, 129, 33-38; gC. Baduel, C. J. Paxman, J. F. Mueller, Journal of Hazardous Materials 2015, 296, 46-53; hR. H. Anderson, G. C. Long, R. C. Porter, J. K. Anderson, Chemosphere 2016, 150, 678-685; iG. Munoz, P. Ray, S. Mejia-Avendaño, S. Vo Duy, D. Tien Do, J. Liu, S. Sauvé, Analytica Chimica Acta 2018, 1034, 74-84; jW. Jouanneau, B.-J. Bårdsen, D. Herzke, T. V. Johnsen, I. Eulaers, J. O. Bustnes, Environmental Science & Technology 2020, 54, 5011-5020; kL. A. D'Agostino, S. A. Mabury, Environmental Science & Technology 2017, 51, 13603-13613; lS. T. M. L. D. Senevirathna, R. Mahinroosta, M. Li, K. KrishnaPillai, Chemosphere 2021, 262, 127606.
[6] aC. Y. Tang, Q. S. Fu, A. P. Robertson, C. S. Criddle, J. O. Leckie, Environmental Science & Technology 2006, 40, 7343-7349; bK. E. Carter, J. Farrell, Separation Science and Technology 2010, 45, 762-767.
[7] X. Xiao, B. A. Ulrich, B. Chen, C. P. Higgins, Environmental Science & Technology 2017, 51, 6342-6351.
[8] G. San Miguel, S. D. Lambert, N. J. D. Graham, Water Research 2001, 35, 2740-2748.
[9] F. Xiao, P. C. Sasi, B. Yao, A. Kubitova, S. A. Golovko, M. Y. Golovko, D. Soli, Environmental Science & Technology Letters 2020, 7, 343-350.
[10] E. National Academies of Sciences, Medicine, Understanding, Controlling, and Preventing Exposure to PFAS: Proceedings of a Workshop—in Brief The National Academies Press, Washington, DC, 2020.
[11] P. Chularueangaksorn, S. Tanaka, S. Fujii, C. Kunacheva, Journal of Applied Polymer Science 2014, 131.
[12] S. T. M. L. D. Senevirathna, S. Tanaka, S. Fujii, C. Kunacheva, H. Harada, B. H. A. K. T. Ariyadasa, B. R. Shivakoti, Desalination 2010, 260, 29-33.
[13] aA. Zygler, M. Słomińska, J. Namiesnik, in Comprehensive Sampling and Sample Preparation (Ed.: J. Pawliszyn), Academic Press, Oxford, 2012, pp. 65-82; bin Encyclopedia of Analytical Chemistry.
[14] C. D. Vecitis, H. Park, J. Cheng, B. T. Mader, M. R. Hoffmann, The Journal of Physical Chemistry A 2008, 112, 4261-4270.
[15] Y. T. Didenko, W. B. McNamara, K. S. Suslick, Journal of the American Chemical Society 1999, 121, 5817-5818.
[16] V. L. Gole, A. Fishgold, R. Sierra-Alvarez, P. Deymier, M. Keswani, Separation and Purification Technology 2018, 194, 104-110.
[17] T. Campbell, M. R. Hoffmann, Separation and Purification Technology 2015, 156, 1019-1027.
[18] C. A. Moody, W. C. Kwan, J. W. Martin, D. C. G. Muir, S. A. Mabury, Analytical Chemistry 2001, 73, 2200-2206.
[19] J. Bräunig, C. Baduel, C. M. Barnes, J. F. Mueller, Science of The Total Environment 2019, 646, 471-479.
[20] F. Chemat, N. Rombaut, A.-G. Sicaire, A. Meullemiestre, A.-S. Fabiano-Tixier, M. Abert-Vian, Ultrasonics Sonochemistry 2017, 34, 540-560.
[21] aM. J. Sweetman, D. Sebben, B. D. Noll, W. H. Wang, S. May, N. Mebberson, S. E. Plush, J. D. Hayball, Water Supply 2017, 18, 371-382; bF. J. Rodriguez, P. Schlenger, M. García-Valverde, Science of The Total Environment 2014, 476-477, 718-730.
[22] R. Baigorri, M. Fuentes, G. Gonzãlez-Gaitano, J. M. Garcia-Mina, G. Almendros, F. J. Gonzãlez-Vila, Journal of Agricultural and Food Chemistry 2009, 57, 3266-3272.
[23] M. S. Siddiqui, G. L. Amy, B. D. Murphy, Water Research 1997, 31, 3098-3106.
[24] Z. Wang, J. C. DeWitt, C. P. Higgins, I. T. Cousins, Environmental Science & Technology 2017, 51, 2508-2518.
[25] J. P. Benskin, A. O. De Silva, J. W. Martin, in Reviews of Environmental Contamination and Toxicology Volume 208: Perfluorinated alkylated substances (Ed.: P. De Voogt), Springer New York, New York, NY, 2010, pp. 111-160.
[26] J. Cheng, C. D. Vecitis, H. Park, B. T. Mader, M. R. Hoffmann, Environmental Science & Technology 2008, 42, 8057-8063.
[27] H. Moriwaki, Y. Takagi, M. Tanaka, K. Tsuruho, K. Okitsu, Y. Maeda, Environmental Science & Technology 2005, 39, 3388-3392.
[28] T. Shende, G. Andaluri, R. P. S. Suri, Ultrasonics Sonochemistry 2019, 51, 359-368.

1. A solvent extraction process for removing poly- and perfluoroalkyl substances (PFAS) from a PFAS laden adsorbent, the process comprising introducing a substantially pure solvent at an elevated temperature to a bed of the PFAS laden adsorbent and continuously removing PFAS laden solvent from the adsorbent, wherein the introducing and removing are carried out simultaneously and continuously until a desired amount of PFAS is removed from the adsorbent.

2. The solvent extraction process of claim 1, wherein the introducing and removing are carried out in a Soxhlet extraction apparatus.

3-4. (canceled)

5. The solvent extraction process of claim 1, wherein the solvent is a C₁-C₆ alcohol.

6. (canceled)

7. The solvent extraction process of claim 5, wherein the C₁-C₆ alcohol is methanol.

8. The solvent extraction process of claim 7, wherein the elevated temperature is at or near the boiling point of the solvent.

9. (canceled)

10. The solvent extraction process of claim 1, wherein the adsorbent is activated carbon.

11. The solvent extraction process of claim 10, wherein the activated carbon is granular activated carbon (GAC).

12. The solvent extraction process of claim 1, wherein the process provides a regenerated adsorbent that is suitable for re-use as an adsorbent for PFAS.

13. (canceled)

14. A process for regenerating an adsorbent from a PFAS laden adsorbent, the process comprising subjecting the PFAS laden adsorbent to the process of claim 1.

15-28. (canceled)

29. A process of degrading poly- and perfluoroalkyl substances (PFAS) to environmentally benign products, the process comprising:
providing an aqueous solution containing PFAS at a concentration of greater than 50 ppm;
subjecting the aqueous solution to ultrasound using at least one ultrasonic transducer at a frequency and power and for a time sufficient to degrade substantially all of the PFAS in the solution to carbon dioxide and fluoride.

30. The process of claim 29, wherein the frequency of the ultrasonic transducer is at least 1000 kHz.

31. The process of claim 30, wherein the frequency of the ultrasonic transducer is 1140 kHz.

32. The process of claim 1, wherein the power of the ultrasonic transducer is at least 200 W/L input.

33. The process of claim 32, wherein the power of the ultrasonic transducer is 250 W/L input.

34. The process of claim 29, wherein the concentration of PFAS in the aqueous solution is about 75 ppm.

35. (canceled)

36. The process of claim 29, wherein the PFAS is degraded at a rate of at from about 1 mg per hour to about 2 mg per hour.

37-38. (canceled)

39. A system for removing poly- and perfluoroalkyl substances (PFAS) from a PFAS laden sorbent and degrading PFAS to environmentally benign products, the system comprising:
a solvent extraction station configured to introduce a substantially pure solvent at an elevated temperature to a bed of the PFAS laden adsorbent and continuously remove PFAS laden solvent from the adsorbent, wherein the introducing and removing are carried out simultaneously and continuously;
a PFAS degradation station configured to degrade PFAS obtained from the solvent extraction station, the degradation station comprising at least one ultrasonic transducer configured to expose an aqueous solution of the PFAS obtained from the solvent extraction station to ultrasound at a frequency and power and for a time sufficient to degrade substantially all of the PFAS in the solution to carbon dioxide and fluoride.
